(19) United States
(12) Patent Application Publication
(10) Pub. No.: US 2005/0280651 A1
(43) Pub. Date: Dec. 22, 2005

(54) Apparatus and method for enhanced video images

(76) Inventor: Berkeley L. Geddes, Gilbert, AZ (US)

Correspondence Address: Wright Law Group, PLLC;Suite 2, 7201 West Oakland, Chandler, AZ, 85226, US

(21) Appl. No.: 11/156,031

(22) Filed: Jun. 17, 2005

Related U.S. Application Data
(60) Provisional application No. 60/581,273, filed on Jun. 18, 2004.

(51) Int. Cl. G09G 5/36

(52) U.S. Cl. 345/547

(57) ABSTRACT

Enhanced video images are provided by an apparatus and method configured to associate one or more “interest markers” with a video stream, preferably in real-time. The combination video stream, comprised of the video output from the imaging machine interspersed with the associated interest markers, can then be segmented into desired “clips” or subsets or the original video stream. The subsets can then be searched, sorted, edited, manipulated, compressed, and eventually stored on a non-volatile output device such as a DASD or digital video recorder for later review and distribution. The interest markers serve as indicators for areas of interest that may be reviewed by a medical professional, such as a radiologist at a later time. Additionally, in a keepsake imaging application, the integrated interest markers can be used to identify high value images of the fetus for final output.

### RELATED APPLICATIONS

This application claims priority under 35 U.S.C. §119(e) to U.S. Provisional Patent Application Ser. No. 60/581,273, filed on Jun. 18, 2004, which application is hereby incorporated by reference in its entirety.

### BACKGROUND OF THE INVENTION

1. Technical Field

The present invention relates to imaging systems and, in particular, to imaging systems that are used to provide medical images and images representing the in utero growth and development of the human fetus.

2. Background Art

Computer-generated images find use in many different industries to model surfaces and solids. In the medical field, computer imaging is used in combination with ultrasound imaging, magnetic resonance imaging or other medical imaging technology to display, analyze and organize the data these medical imaging technologies provide. For example, ultrasound machines use ultrasonic waves, i.e. sonar, to scan a patient's body. Radiologists and/or other medical practitioners analyze and use the data obtained by various imaging technologies to assist in the diagnosis and treatment of patients. Ultrasound machines are typically used for activities such as viewing a fetus, analyzing blood-flow patterns in arteries, or scanning organs for irregularities such as cysts, etc.

In addition to traditional medical and diagnostic imaging applications, alterative uses of imaging include the burgeoning field of “keepsake” imaging. While utilizing the same general equipment and methodology as traditional medical and diagnostic imaging applications, keepsake imaging serves a different purpose. Instead of focusing on the identification and exploration of abnormalities and potential issues of concern, keepsake imaging is utilized to provide additional opportunities for parents to understand and appreciate the growth and development of their unborn child. By providing an early image of a developing child to the expectant parents, the important bonds of love and affection can be strengthened. Few parents can fail to appreciate the wonder of a developing life when presented with vivid images of their rapidly growing child.

Typically, in most imaging applications, a three-dimensional image is projected on a two-dimensional surface such as a video screen or a print out and displayed to a user. Computer systems have been devised that permit the user to take different cross-sectional views of the image, thereby enabling a user to view a portion of the three dimensional image by choosing one or more cross-sectional views. Some computer systems also permit the user to geometrically transform the image by rotating, translating and scaling the image, and also permit the user to take cross-sectional views at different orientations, such that the user can sequentially view the three-dimensional image using a series of oblique planes.

Other computer-based imaging systems take a different approach; instead of showing a cross-section of the three-dimensional image, they “render” the volume by making part of the volume transparent or translucent such that points under those parts are revealed. In a maximum intensity display, for example, the highest intensity points along a line parallel to the line of sight of the user are shown, similar to an x-ray picture of a foot. Finally, more sophisticated ultrasound imaging systems will also incorporate the time element, thereby creating a video stream or movie, known as a “cine loop” of the ultrasound images.

Conventional ultrasound imaging systems typically include a hand-held probe coupled by cables to a large rack-mounted console incorporating a processing and display unit. The probe typically includes an array of ultrasonic transducers that transmit ultrasonic energy into a region being examined and receive reflected ultrasonic energy returning from the region. The transducers convert the received ultrasonic energy into low-level electrical signals that are transferred over the cable to the processing unit. The processing unit applies appropriate beam forming techniques to combine the signals from the transducers to generate an image of the region of interest.

Many conventional ultrasound systems also include a transducer array with each transducer being associated with its own processing circuitry located in the console processing unit. The processing circuitry typically includes driver circuits which, in the transmit mode, send precisely timed drive pulses to the transducer to initiate transmission of the ultrasonic signal. These transmit timing pulses are forwarded from the console processing unit along the cable to the probe. In the receive mode, beamforming circuits of the processing circuitry introduce the appropriate delay into each low-level electrical signal from the transducers to dynamically focus the signals such that an accurate image can subsequently be generated.

There are usually several steps involved in providing a diagnosis of a patient based on an ultrasound examination. First, the ultrasound examination is generally performed using an ultrasound imaging system substantially as described above. The images generated from this examination can then be digitally stored and reviewed by a physician on an ultrasound review station, which is typically coupled with an ultrasound imaging system though a network. The ultrasound review station can display images, text, and measurement and calculation data generated during the ultrasound examination and can also be used to facilitate the production of various ultrasound examination reports. Based on the analysis at the review station, the physician typically generates an ultrasound examination report to provide a diagnosis for medical treatment. Often, a physician will dictate the diagnosis onto an audiotape or recording system, and the diagnosis is later transcribed and entered into an ultrasound examination report. Alternatively, in certain ultrasound devices, the diagnosis can be typed into the ultrasound imaging system.

While the overall process for keepsake imaging is similar to the process for conventional medical imaging, the focus of the medical professional is somewhat different. For keepsake imaging, the goal is not to provide a medical opinion or diagnosis, but to provide a video stream that is representative of the growth and development of the fetus so as to allow the expectant parents to more fully understand and appreciate the new life that will soon arrive and become part of their family.

While three-dimensional images from state-of-the-art ultrasound examinations provide a wealth of information, filtering out the information that is of interest from irrelevant information can be a very time-consuming process for the medical professional. This is especially true for medical images in which the anatomical feature or areas of interest are often obscured from clear view by other physical features or where the areas of interest are presented only intermittently during the course of an ultrasound examination. In this case, it may be necessary for the physician or technician to review extended segments of the ultrasound image stream in order to review the areas of interest in a diagnostic review session. This is very inefficient and may lead to substandard diagnostic reviews due to the tedium and inattentiveness inherent in the process. In the keepsake imaging arena, many recorded ultrasound images may be difficult to interpret and, based on the position of the fetus, may not provide the desired visual perspective for the prospective parents.

Accordingly, there remains a need for an apparatus and methods for quickly and easily analyzing and manipulating images in order to filter out as much irrelevant information as possible from the images and focus only the areas of interest, thereby providing the desired information in the most accessible format possible. Without certain improvements or advancements over the existing state-of-the-art equipment and procedures, capturing and reviewing ultrasonic images for their desired purposes will remain sub-optimal.

### BRIEF SUMMARY OF THE INVENTION

The present invention provides an apparatus and method for inserting “interest markers” into a video stream, preferably in real-time. The combination video stream, comprised of the output from the imaging machine interspersed with the integral interest markers, can then be edited, manipulated, compressed, and eventually stored on a non-volatile output device such as a DASD or digital video recorder for later review and distribution. The interest markers can serve as indicators for diagnostic areas of interest that may be reviewed by a medical professional, such as a radiologist at a later time. Additionally, in the case of keepsake ultrasound images, the technician can insert the interest markers to highlight the most likely sequences of images for inclusion in a keepsake video stream.

In the most preferred embodiments of the present invention, the interest markers can be categorized and identified on screen by one or more representative icons or other identifying indicia. By inserting a plurality of categorized interest markers, the medical professional can quickly and easily review only those areas of concern in a diagnostic session, bypassing less critical areas of evaluation for those of greater importance. Similarly, in a keepsake session, the interest markers can be used to identify high value images of the fetus for final output. Finally, the use of interest markers allows for the creation of subsets or “clips” from the original video stream, with each subset or clip being selected based on the interest markers previously associated with the original video stream.

### BRIEF DESCRIPTION OF THE DRAWINGS

The preferred embodiments of the present invention will hereinafter be described in conjunction with the appended drawings, wherein like designations denote like elements, and:

FIG. 1 is a block diagram of a computer-based system for producing enhanced video streams in accordance with a preferred exemplary embodiment of the present invention;

FIG. 2 is a block diagram of a computer system used in conjunction with an apparatus for producing enhanced video streams in accordance with a preferred exemplary embodiment of the present invention.

FIG. 3 is a representative view of sample image, with integral interest markers, generated by a computer-based system for producing enhanced video streams in accordance with a preferred exemplary embodiment of the present invention;

FIG. 4 depicts a method of inserting interest markers into a video stream in accordance with a preferred exemplary embodiment of the present invention; and

FIG. 5 depicts a method of modifying an enhanced video stream in accordance with a preferred exemplary embodiment of the present invention

### DETAILED DESCRIPTION

A combination video stream, comprised of the output from an imaging machine interspersed with the integral interest markers, can be edited, manipulated, compressed, and eventually stored on a non-volatile output device for later review and distribution. The interest markers can serve as indicators for diagnostic areas of interest that may be reviewed by a medical professional, such as a radiologist at a later time. Additionally, in the case of keepsake ultrasounds, the technician can insert the interest markers to highlight the most likely sequences of images for inclusion in a keepsake video stream.

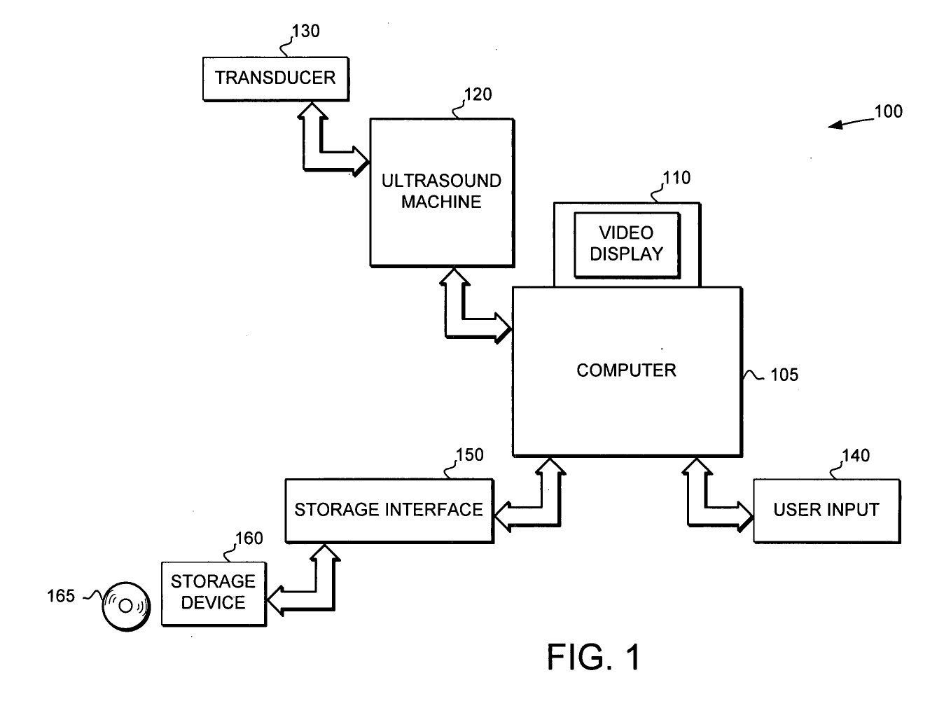

Referring now to FIG. 1, a computer-based system 100 for producing enhanced video streams in accordance with a preferred exemplary embodiment of the present invention includes an ultrasound machine 120; a transducer 130 connected to ultrasound machine 120; a computer 105; a user input device 140 connected to computer 105; a video display 110 connected to computer 105; and a storage device 160 connected to computer 105 via storage interface 150. Storage device 160 may be configured to utilize removable storage 165. Once again, although described in the context of an ultrasound imaging environment, those skilled in the art will recognize that the present invention may be adapted to incorporate a wide variety of imaging devices including CT imaging devices and MRI imaging devices.

Ultrasound machine 120 is any type of ultrasound machine known to those skilled in the art. In the most preferred embodiments of the present invention ultrasound machine 120 is a GE Voluson 730. Those skilled in the art will recognize that any type of conventional ultrasound machine that is capable of producing a video stream of the ultrasound procedure may be utilized in one or more preferred embodiments of the present invention. Transducer 130 is coupled to ultrasound machine 120 and represents any typical transducer known to those skilled in the art that can be used to provide the appropriate input signals for ultrasound machine 120. Those skilled in the art will also recognize that other peripheral equipment may be associated with ultrasound machine 120 without departing from the spirit or scope of the present invention.

Computer 105 represents any type of computer system known to those skilled in the art that is capable of being configured for use with computer-based system 100 as described herein. This includes laptop computers, desktop computers, tablet computers, pen-based computers and the like. Computer system 105 is most preferably a commercially available computer system such as a Linux-based computer system, IBM compatible computer system, or Macintosh computer system. However, those skilled in the art will appreciate that the methods and apparatus of the present invention apply equally to any computer system, regardless of whether the computer system is a traditional “mainframe” computer, a complicated multi-user computing apparatus or a single user device such as a personal computer or workstation.

Although computer 105 is illustrated as being physically separate from ultrasound machine 120 in FIG. 1, those skilled in the art will recognize that most presently known ultrasound machines 120 are capable of supporting the various hardware and software requirements of the present invention and, accordingly, certain embodiments of the present invention will combine ultrasound machine 120 and computer 105.

Additionally, handheld and palmtop devices are also specifically included within the description of devices that may be deployed as computer system 105. It should be noted that no specific operating system or hardware platform is excluded and it is anticipated that many different hardware and software platforms may be configured to create computer system 105. Additionally, various hardware components and software components (not shown this FIG.) known to those skilled in the art may be used in conjunction with computer system 105. It should be noted that in the most preferred embodiments of the present invention, computer system 105 may be linked to its own local area network (LAN) or wide area network (WAN) and may have access to its own data server (not shown this FIG.).

Video display 110 represents any type of visual display apparatus capable of displaying the images produced by ultrasound machine 120. This includes TFT flat panel displays and standard CRT displays as well as other display devices known to those skilled in the art. In certain preferred embodiments of the present invention, such as those embodiments that incorporate a laptop computer, video display 110 maybe physically integrated into computer system 105, thereby forming a single physical unit. In at least some preferred embodiments of the present invention, video display 110 is a touch screen display that can accept user input based on the user's physical touch.

Storage device 160 includes any type of electronic data storage device known to those skilled in the art. This includes any type of information storage device including a Direct Access Storage Device (DASD) such as a hard disk drive, CD-RW drive, DVD recordable drive, Magneto Optical (MO) drive, or a digital video recorder. Additionally, storage device 160 may be a standard VHS video recorder. Although shown as a single device, it should also be noted that storage device 160 may include multiple storage devices with each storage device storing all or part of the ultrasound image stream produced by ultrasound machine 120. While storage device 160 is depicted as being external to computer system 105, storage device 160 may be internal and integrated directly computer system 105. Storage interface 150 is a connection configured to support the transfer of digital data from computer system 105 to storage device 160. The use of storage interface 150 is well known to those skilled in the art.

User interface device 140 is any type of input device known to those skilled in the art. This includes devices such as track balls, keyboards, mice, tablets, etc. The user of computer 105 can use utilize user interface device 140 to interact with computer 105 and to insert interest markers at any time an in any part of the ultrasound image stream produced by ultrasound machine 120.

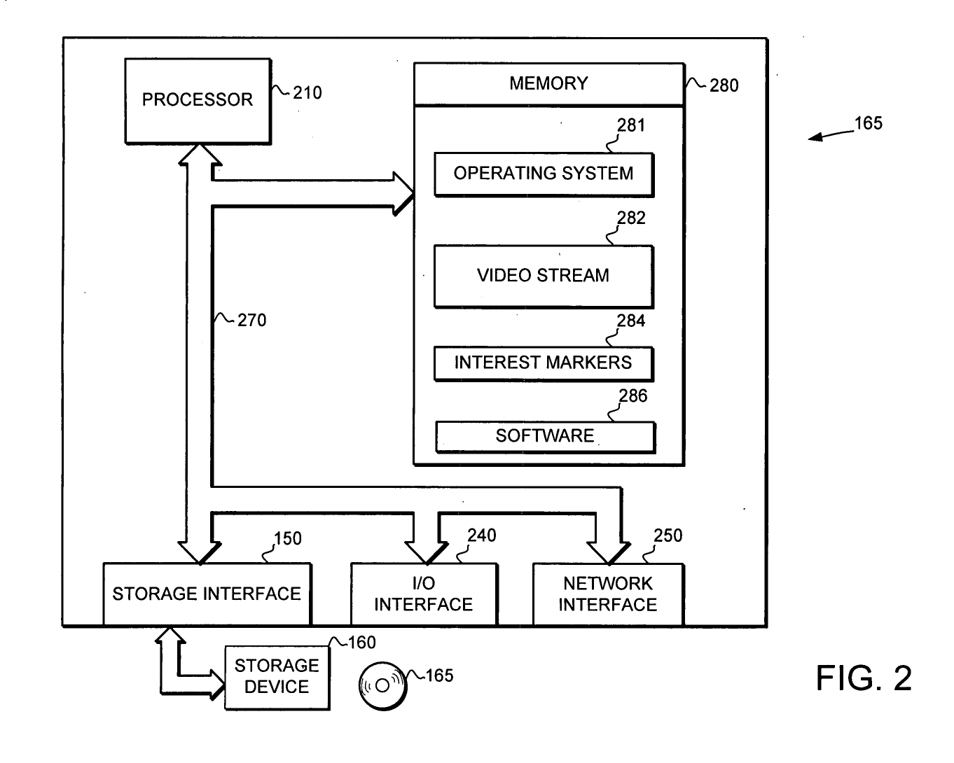

Referring now to FIG. 2, a computer 105 used in conjunction with computer-based system 100 for producing enhanced video streams in accordance with a preferred exemplary embodiment of the present invention includes a processor 210, a memory 280 coupled to processor 210, a bus 270, a storage interface 150, an 10 interface 240, and a network interface 250.

Computer 105 represents a relatively powerful computer system that is connected to and made available to the various components of computer-based system 100. Various hardware components (not shown this FIG.) such as external monitors, keyboards, mice, tablets, hard disk drives, recordable CD-ROM/DVD drives, jukeboxes, fax servers, magnetic tapes, and other devices known to those skilled in the art may be used in conjunction with computer 105. Computer 105 may also be configured with various additional software components (not shown this FIG.) such as database servers, web servers, firewalls, security software, and the like. The use of these various hardware and software components is well known to those skilled in the art. Given the relative advances in the state-of-the-art computer systems available today, it is anticipated that functions of computer system 105 may be provided by many standard, readily available computer systems. Depending on the desired size and relative power required for computer system 105, storage area network (SAN) technology may also be deployed in certain preferred embodiments of the present invention. Additionally, devices for creating and verifying digital signatures (i.e., electronic signature processing) may also be included.

Processor 210 performs computation and control functions of computer 105, and comprises a suitable central processing unit (CPU). Processor 210 may comprise a single integrated circuit, such as a microprocessor, or may comprise any suitable number of integrated circuit devices and/or circuit boards working in cooperation to accomplish the functions of a processor. Processor 210 suitably executes one or more software programs contained within main memory 280.

Main memory 280 suitably contains an operating system 281, a video stream 282, at least one interest marker 284, and manipulation software 286. The term “memory” as used herein refers to any storage location in the virtual memory space of computer 105. It should be understood that main memory 280 may not necessarily contain all parts of all components shown. For example, portions of operating system 281 may be loaded into an instruction cache (not shown) for processor 210 to execute, while other files may well be stored on magnetic or optical disk storage devices (not shown).

In addition, although video stream 282, at least one interest marker 284, and manipulation software 286 are all shown to reside in the same memory location as operating system 221, it is to be understood that main memory 280 may consist of multiple disparate memory locations. It should also be noted that any and all of the individual components shown in main memory 280 may be combined in various forms and distributed as a stand-alone program product. Finally, it should be noted that additional components, not shown in this figure may also be included.

For example, while not required, most preferred embodiments of the present invention will include a security and/or encryption mechanism for verifying access to the data and protecting the information contained in, processed by, and transmitted by computer 105. The security and/or encryption mechanism may be incorporated into operating system 221. Additionally, the security mechanism may also provide encryption capabilities for computer-based system 100 of FIG. 1, thereby enhancing the robustness of computer-based system 100 and providing for compliance with various data protection requirements such as HIPAA. Additionally, the level and type of security measures applied by the security system may be determined by the nature of a given request and/or response, including the identity of the requestor. In some preferred embodiments of the present invention, the security mechanism may be contained in or implemented in conjunction with certain hardware components (not shown this FIG.) such as hardware-based firewalls, routers, switches, dongles, and the like.

Storage interface 150 allows computer 105 to store and retrieve information from auxiliary storage devices, such as storage device 160, magnetic disk drives (e.g. hard disks or floppy diskettes) or optical storage devices (e.g., CD-ROM). One such suitable storage device is storage device 160. As shown in FIG. 2, storage device 160 may be a disk drive that may read programs and data to/from a disk 165.

It is important to note that while the present invention has been (and will continue to be) described in the context of a fully functional computer system, those skilled in the art will appreciate that the various software mechanisms of the present invention are capable of being distributed in conjunction with signal bearing media as one or more program products in a variety of forms, and that the various preferred embodiments of the present invention applies equally regardless of the particular type or location of signal bearing media used to actually carry out the distribution. The term “signal bearing media” as used herein refers to any medium that participates in providing data (e.g., instructions) that may be read by a computer, a processor or similar device.

Such a medium may take many forms, including but not limited to, non-volatile media, volatile media, and transmission media. Non-volatile media include, for example, optical or magnetic disks and other persistent memory. Volatile media include dynamic random access memory (DRAM), which typically constitutes the main memory. Transmission media include coaxial cables, copper wire and fiber optics, including the wires that comprise a system bus coupled to the processor. Transmission media may also include or convey acoustic waves, light waves and electromagnetic emissions, such as those generated during radio frequency (RF) and infrared (IR) data communications.

Common forms of computer-readable media include, for example, a floppy disk, a flexible disk, hard disk, magnetic tape, any other magnetic medium, a CD-ROM, DVD, any other optical medium, punch cards, paper tape, any other physical medium with patterns of holes, a RAM, a PROM, an EPROM, a FLASH-EEPROM, any other memory chip or cartridge, a carrier wave as described hereinafter, or any other medium from which a computer can read. Specific examples of signal bearing media include: recordable type media such as floppy disks (e.g., disk 165) and CD ROMS, and transmission type media such as digital and analog communication links, including wireless communication links.

I/O Interface 240 is provided so that various types of data may be communicated to and from computer 105 via additional external devices coupled to computer 105 via I/O interface 240. This includes selectively connectable peripheral devices such as external monitors, printers, modems, etc. Each of these selectively connectable peripheral devices will be configured to communicate with computer 105 and transmit and/or receive data to and from computer 105. In the most preferred embodiments of the present invention, a DVD recorder or VHS video recorder may be connected to computer 105 via I/O interface 240 so that at least some portion of ultrasound video stream 282 may be transferred to the recordable media contained in the DVD recorder or VHS video recorder and stored in a non-volatile format for future review.

Network interface 250 is provided to connect computer 105 to various networks including local area networks, intranets, wide area networks and/or global computer networks such as the Internet. This configuration allows computer 105 to readily communicate with other computer systems and to transmit data to and from various locations. The physical connection may be a wired or wireless connection including those connections using standards such as 802.11x and Ethernet cat 5 cable.

Video stream 282 represents a digitized video signal transmitted from an imaging device such as ultrasound machine 120. Video stream 282 is transferred to computer 105 and stored in main memory 280 where it may be manipulated by software 286. Video stream 282 represents one or more separate digitized video streams, each of which may be edited, modified, compressed, stored, combined, and/or transmitted.

Interest markers 284 represent user-identified areas or points of interest displayed in video stream 282. This includes one or more visual markers and may include audio markers as well. Interest markers 284 are identified by a user of system 100 of FIG. 1 while the user is viewing video stream 282. In the most preferred embodiments of the present invention, the user will view video stream 282 in real time (i.e., as it is generated by ultrasound machine 120) and, using user input device 140, interactively identify one or more interest markers 284 while viewing video stream 282. As they are identified, interest markers 284 are associated with the specific frame or frames of video stream 282 and, where so identified, may also be associated with a specific screen image or portion of video stream 282.

Additionally, the exact categories, representative icons, and content of interest markers 284 are all user-selectable and adjustable by the user of system 100. In this fashion, each user of system 100 can configure and customize interest markers 284 so as to most accurately capture and portray the information desired by the user of system 100. The configuration, adaptation, and insertion of interest markers into video stream 282 is accomplished via software 286.

In the case of an audio interest marker 284, the user may provide an audio commentary regarding the visual images being displayed on video display 110 by using a microphone or similar device. The audio interest marker may be used to identify a particular image contained in video stream 282 and or a description of the contents of video stream 282.

For those embodiments where video display 110 is implemented as a touch screen display, the user of system 100 will select and insert one or interest markers 284 by touching the desired areas of video display 110. In this fashion, one or more interest markers 284 can be integrated into video stream 282.

Software 286 represents a computer software application or imaging mechanism that is capable of displaying and manipulating video stream 282. Software 286 is capable of operating in a medical diagnostic imaging mode and a keepsake imaging mode. In the medical diagnostic imaging mode, visual interest markers will be associated with those portions of the image that pertain to the appropriate diagnostic procedures or protocols. In the keepsake imaging mode, visual interest markers will be focused on identifying areas of interest for observing the growth and development of the fetus.

In the most preferred embodiments of the present invention, software 286 incorporates a user interface that allows the user to view video stream 282 in real time and selectively associate one or more visual interest markers 284 with a specific portion or portions of video stream 282. Software 286 is configured to integrate video stream 282 and one or more visual interest markers 284 into a single video stream. Additionally, the user can identify one or more subsets of video stream 282 to create one or more “clips” that can be reorganized, edited, combined, etc.

Additionally, software 286 is capable of merging two or more selected views or clips from video streams 282, compressing video stream 282, and editing and/or storing one or more ultrasound video streams 282. Finally, software 286 is capable of integrating audio interest markers 284 into video stream 282, thereby creating enhanced images and video streams. The enhanced video streams can be output and stored in a wide variety of formats including MPEG, AVI, MJPEG, etc.

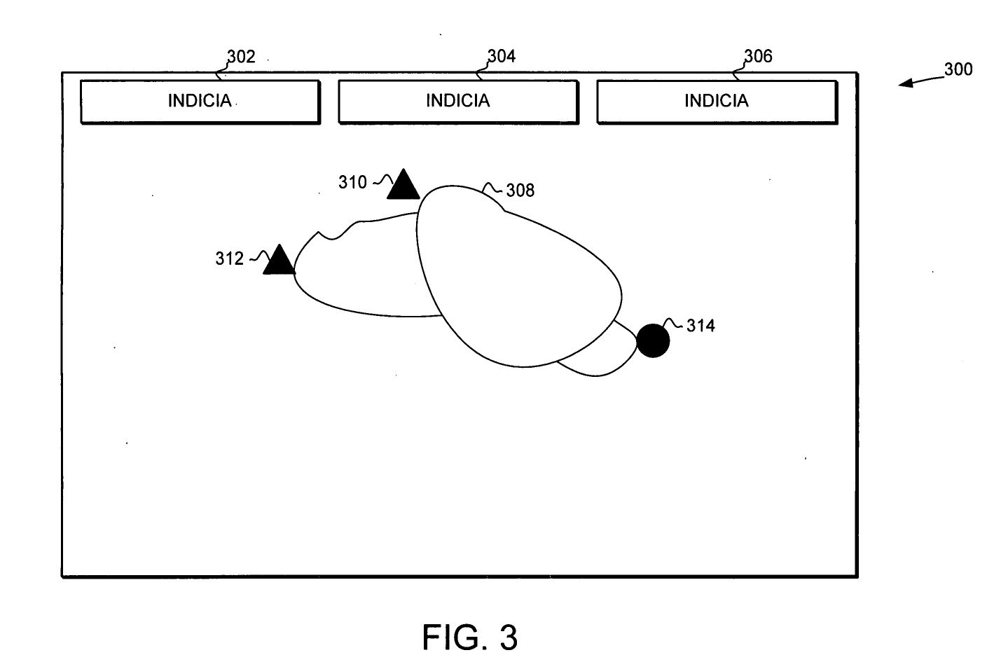

Referring now to FIG. 3, a sample screen image 300 in accordance with a preferred exemplary embodiment of the present invention includes an object of interest 308 with interest marker 310, interest marker 312, and interest marker 314. Ultrasound screen image 300 is representative of a single frame taken from a video stream 282 and displayed on video display 110 of FIG. 1. Given that video stream 282 is a continuous video stream, each video stream 282 contains multiple ultrasound screen images 300.

Sample screen image 300 represents a composite or enhanced image created from video stream 282 from FIG. 2 and the user-selected and associated interest markers 310, 312, and 314. Sample screen image 300 also includes optional indicia 302, optional indicia 304, and optional indicia 306. Sample screen image 300 represents a “time slice” or single screen shot taken from an image stream, and is representative of many similar images continuously streamed to the video display and viewed by the user of the imaging machine during a typical examination.

Object of interest 308 may be representative an image of a skeletal feature, an organ, a fetus, or the like. Interest markers 312, 314, and 316 are representative of the type of interest markers that may be utilized in various preferred embodiments of the present invention. In this example, interest markers 310 and 312 are similar in appearance because they represent interest markers with the same categorization. Interest marker 314 is representative of an interest marker with a different categorization. While shown here with representative shapes, it should be noted that any type of symbol, icon, or indicia may be used as interest markers in various preferred embodiments of the present invention.

As previously explained, in addition to visual interest markers 312, 314, and 316, audio interest markers may also be associated with a screen image 300. Audio interest markers may incorporate commentary regarding object of interest 308. Both audio and visual interest markers, when selectively associated with a video stream 282 may extend over a series of adjacent frames, creating an integrated video clip.

Optional indicia 302, optional indicia 304, and optional indicia 306 are typical indicators included in a screen display as part of video stream 282 from ultrasound machine 120. These optional indicia 302, 304, and 306 may include information such as the date and time of the imaging examination and additional information regarding the operational or performance aspects of ultrasound machine 120. In the most preferred embodiments of the present invention, optional indicia 302, optional indicia 304, and optional indicia 306 may be “masked” or removed prior to the storage of the combination image stream on storage device 160 of FIG. 2. Finally, one or more “clips” or subsets of the original video stream may be transferred to external storage and stored or recorded onto a non-volatile medium such as DVDs or VHS video tapes.

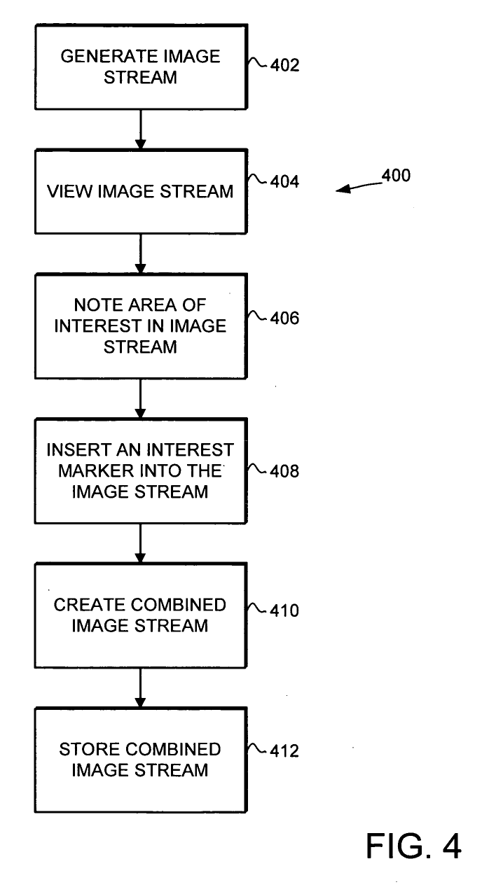

Referring now to FIG. 4, a method 400 of associating interest markers with a video stream in accordance with a preferred exemplary embodiment of the present invention is depicted. As shown in FIG. 4, an image stream is generated from any one of possible sources such as a standard ultrasound machine (step 402). A technician or diagnostician views the image stream (step 404) and notes one or more areas of interest in the image stream (step 406). Once an area of interest has been noted by the user, one or more interest markers can be associated with a portion of the video stream (step 408) and a combined image stream can be created (step 410).

The interest markers can be used to identify any area of the image for later review, study, and/or diagnosis. As previously explained, the interest markers may be visual interest markers and/or audio interest markers. These user-customizable and user-configurable interest markers can be associated with any length of video clip. The combined image stream is most preferably created in real-time by combining the image stream with the interest markers as they are selected by the operator of the imaging apparatus. Finally, the combined image stream can be stored on a non-volatile storage mechanism as described in conjunction with FIG. 1 and FIG. 2 (step 412).

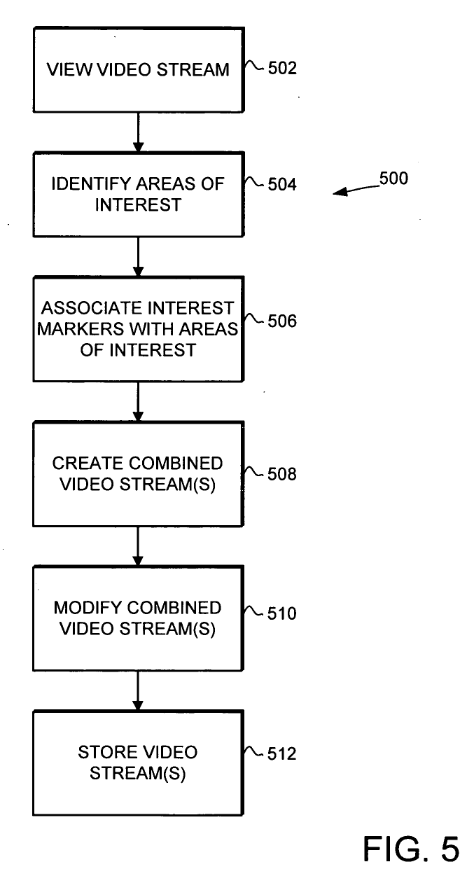

Referring now to FIG. 5, a method 500 for modifying an enhanced video stream in accordance with a preferred embodiment of the present invention is shown. A technician or diagnostician views the image stream (step 502) and identifies one or more areas of interest in the image stream (step 504). Once an area of interest has been identified by the user, one or more interest markers can be associated with a portion of the video stream via a user interface (step 506) and an enhanced image stream can be created (step 508). Once the enhanced image stream has been created, the user can use the user interface of the software application to modify the enhanced video stream (step 510) and then store the resultant modified enhanced video stream or streams (step 512).

In the context of the present invention, the term “modify” means providing the capability via the user interface to create one or more subsets or clips from the original enhanced video stream based on the interest markers, reorder the clips created from the original video stream based on the interest markers, sort the clips by interest marker, etc.

In the most preferred embodiments of the present invention, the interest markers have identifying characteristics associated with each individual interest marker or group of interest markers. For example, one group of interest markers may be coded so as to indicate all areas of the image stream that are related to the internal organs of the subject of the image or video stream. Similarly, another interest marker or group of interest markers may be coded so as to indicate all areas of the image stream that are related to the skeletal structure of the subject of the image.

In this fashion, the identifying characteristics associated with the interest markers will allow one or more subsets of the enhanced image stream to be reviewed for specific areas of interest or concern. For example, the technician may view the video stream and use one or more visual interest markers to highlight or point out anomalies or areas of concern regarding the image being viewed. That may include possible birth defects and/or developmental problems with a fetus. Similarly, an audio interest indicator may include a commentary about the images displayed in conjunction with the video stream. By selectively associating the appropriate interest indicators with the areas of concern and then selectively extracting the video clips of interest based on the selected interest indicators, it will be possible to quickly and easily review only those areas of concern in a review session. This will save time and effort, allowing the medical professionals to focus only on the areas of concern. These various interest markers can allow the desired segment or segments to be selected, organized, and stored as a group, independent of the remaining video stream.

In the keepsake operational mode, the interest markers may be used for identifying image sequences for later inclusion in a keepsake image. For example, while viewing the video stream, the operator may use the interest indicators to highlight or point out the head of the fetus and include an audio interest indicator that provides commentary about the fetus such as the stage of development, the sex of the fetus, and other similar elements that would be of interest to the prospective parents. These various interest markers can allow the desired segment or segments to be selected, organized, and stored as a group, independent of the remaining video stream.

Finally, regardless of the specific content of the original video stream, the ability of the interest markers to identify and select specific subsections of the original video stream allows for efficient and effective review of the desired footage. For example, after creating one or more composite video streams, the user can select one or more subsets or clips of one or more composite video streams and further edit the clips and/or rearrange the clips prior to storing the composite video streams on non-volatile storage. In the case of a DVD non-volatile storage medium, the selected subsets can be automatically grouped into DVD “chapters” when the DVD is created, thereby allowing instant access to only the desired footage. In this fashion, a single DVD may contain the original video stream in its entirety as well as one or more subsets of the original video stream grouped into logical groupings based on the previously associated interest markers.

Additionally, the association of interest markers with specific content in the original video stream allows the original video stream to be searched, sorted, organized, edited, etc. all based on the various interest markers that have been associated with the content of the original video stream.

From the foregoing description, it should be appreciated that improved apparatus and methods for marking images for later review and diagnosis is provided and presents significant benefits that would be apparent to one skilled in the art. Furthermore, while multiple embodiments have been presented in the foregoing description of the preferred embodiments, it should be appreciated that a vast number of variations in the preferred embodiments exist. For example, while presented in the context of ultrasound video imaging and ultrasound video streams, those skilled in the art will recognize that the various preferred embodiments of the present invention can be readily adapted to other forms of imaging (i.e., tomography, MRI, CT scans, etc.). Any device that is capable of providing a video output can be utilized with one or more preferred embodiments of the present invention. By capturing the video stream and associating one or more interest markers with the video stream, the present invention will create enhanced video streams for efficient and effective future analysis.

Lastly, it should be appreciated that these illustrative embodiments are preferred exemplary embodiments only, and are not intended to limit the scope, applicability, or configuration of the invention in any way. Rather, the foregoing detailed description provides those skilled in the art with a convenient road map for implementing various preferred exemplary embodiments of the invention, it being understood that various changes may be made in the function and arrangement of elements described in the exemplary preferred embodiments without departing from the spirit and scope of the invention as set forth in the appended claims.

1. An apparatus comprising:
a processor;
a memory coupled to said processor;
a video stream stored in said memory;
an input device configured for manipulation by a user, said input device being coupled to said processor; and
a software mechanism residing in said memory, said software mechanism providing a user interface whereby said user associates at least one interest marker with a least a portion of said ultrasound video stream, thereby creating an enhanced video stream, said software mechanism being configured to modify said enhanced video stream based on said at least one interest marker.

2. The apparatus of claim 1 further comprising a non-volatile storage device coupled to said processor, said storage device being configured to store said enhanced video stream.

3. The apparatus of claim 1 wherein said at least one interest marker comprises a visual interest marker, said visual interest marker highlighting at least a portion of said enhanced video stream.

4. The apparatus of claim 1 wherein said at least one interest marker comprises an audio interest marker, said audio interest marker providing a commentary on at least a portion of said enhanced video stream.

5. The apparatus of claim 1 wherein said software mechanism is configured to extract at least one clip from said enhanced video stream based on said at least one interest marker.

6. The apparatus of claim 1 wherein said at least one interest marker comprises a plurality of interest markers, said plurality of interest markers being associated with a plurality of clips from said enhanced video stream, said plurality of subsets being organized and stored on a non-volatile storage medium according to said plurality of interest markers.

7. The apparatus of claim 6 wherein said software mechanism is configured to locate a specific subset of said enhanced video stream based on at least one of said plurality of interest markers being associated with said specific subset of said enhanced video stream.

8. The apparatus of claim 6 wherein said plurality of interest markers are categorized to provide for the categorization of said specific subset of said enhanced video stream.

9. The apparatus of claim 1 wherein said software mechanism is configured to automatically create and organize a plurality of clips generated from said enhanced video stream and then store said plurality of clips on a non-volatile storage medium.

10. A method comprising the steps of:
viewing a video stream;
identifying at least one area of interest contained in said video stream;
associating at least one interest marker with at least a portion of said video stream, thereby creating an enhanced video stream; and
modifying said video stream based on said at least one interest marker associated with said enhanced video stream.

11. The method of claim 10 wherein said step of modifying said video stream based on said at least one interest marker associated with said enhanced video stream comprises at least one of:
selecting a subset of said enhanced video stream based on said at least one interest marker associated with said enhanced video stream;
rearranging the sequence of a plurality of subsets of said enhanced video stream based on said at least one interest marker associated with said enhanced video stream;
searching for at least one of a plurality of subsets of said enhanced video stream based on said at least one interest marker associated with said enhanced video stream.

12. The method of claim 10 further comprising the step of storing at least a portion of said combined video stream on a non-volatile output device.

13. The method of claim 10 wherein said at least one interest marker comprises a visual interest marker.

14. The method of claim 10 wherein said at least one interest marker comprises an audio interest marker.

15. The method of claim 10 wherein said at least one interest marker comprises a visual interest marker and an audio interest marker.

16. A program product comprising:
a software mechanism, said software mechanism being configured to display a video stream and selectively associate at least one interest marker with at least a portion of said video stream, thereby creating an enhanced video stream, said software mechanism being configured to modify said enhanced video stream based on said associated at least one interest marker; and
signal bearing media bearing said software mechanism.

17. The program product of claim 16 wherein said signal bearing media comprises recordable media.

18. The program product of claim 16 wherein said signal bearing media comprises transmission media.

19. The program product of claim 16 wherein said at least one interest marker comprises a visual interest marker, said visual interest marker highlighting at least a portion of said composite video stream.

20. The program product of claim 16 wherein said at least one interest marker comprises a audio interest marker, said audio interest marker providing a commentary on at least a portion of said composite video stream.
